(19) United States
(12) Patent Application Publication
(10) Pub. No.: US 2020/0301205 A1
(43) Pub. Date: Sep. 24, 2020

(54) DISPLAY DEVICE

(71) Applicants: HONG FU JIN PRECISION INDUSTRY (ShenZhen) CO., LTD., Shenzhen (CN); HON HAI PRECISION INDUSTRY CO., LTD., Shenzhen (CN)

(72) Inventors: HUNG-NAN TAI, New Taipei (TW); JING-XIAO YUAN, Yantai (CN); GUO-DONG WU, Yantai (CN)

(21) Appl. No.: 16/394,399

(22) Filed: Apr. 25, 2019

(30) Foreign Application Priority Data
Mar. 19, 2019 (CN) 201910208425.4

(51) Int. Cl. G02F 1/1335; G02F 1/1333

(52) U.S. Cl. CPC G02F 1/133606; G02F 2001/133331; G02F 1/133611; G02F 1/133308

(57) ABSTRACT

A display device includes a front frame, a backlight module, and a glass plate. The glass plate is arranged facing the backlight module. The front frame includes a main body and a connecting portion. The main body surrounds the backlight module and the glass plate and includes an inner side surface facing the backlight module and the glass plate. The connecting portion extends from the inner side surface into a gap between the backlight module and the glass plate. The backlight module abuts against a side of the connecting portion facing away from the glass plate. A filling is filled in between the backlight module and the inner side surface. The filling is formed by curing a liquid colloid.

### FIELD

The subject matter herein generally relates to display devices, and more particularly to a display device having improved light leakage prevention and a method of making the display device.

### BACKGROUND

Generally, display devices have various modules or structures which need to be joined together by specialized auxiliary structures. However, due to high structural matching precision requirements and special requirements of materials of the auxiliary structures, a manufacturing cost is high and versatility is poor, which results in poor light leakage prevention across different display devices.

### BRIEF DESCRIPTION OF THE DRAWINGS

Implementations of the present disclosure will now be described, by way of embodiments, with reference to the attached figures.

FIG. 1 is a cross-sectional view of an embodiment of a display device.

FIG. 2 is a flowchart of an embodiment of a method for making a display device.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

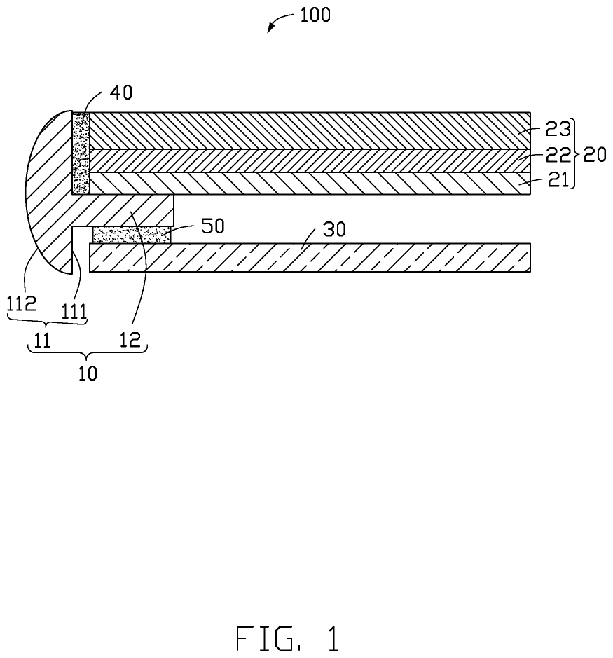

FIG. 1 shows an embodiment of a display device 100 including a front frame 10, a backlight module 20, and a glass plate 30. The glass plate 30 is disposed facing the backlight module 20. The front frame 10 surrounds the backlight module 20 and the glass plate 30 and contacts the backlight module 20 and the glass plate 30.

The glass plate 30 may be a liquid crystal display, such as a thin film transistor-liquid crystal display (TFT-LCD).

The front frame 10 includes a main body 11 and a connecting portion 12. The main body 11 is disposed around the backlight module 20 and the glass plate 30. The main body 11 includes an inner side surface 111 facing the backlight module 20 and the glass plate 30. The connecting portion 12 extends from the inner side surface 111 into a gap between the backlight module 20 and the glass plate 30. The backlight module 20 and the glass plate 30 are respectively located on opposite sides of the connecting portion 12.

In one embodiment, the connecting portion 12 is substantially plate-shaped and extends perpendicularly from the inner side surface 111. The main body 11 further includes an outer side surface 112 facing away from the backlight module 20 and the glass plate 30. In one embodiment, the outer side surface 112 is a curved surface.

The backlight module 20 abuts against a side of the connecting portion 12 facing away from the glass plate 30, and a liquid colloid is filled in between the backlight module 20 and the inner side surface 111 and cured to form a filling 40. The filling 40 fills in a gap between the backlight module 20 and the inner side surface 111.

The backlight module 20 includes a light guide plate 21, a diaphragm 22, and a backplane 23. The light guide plate 21, the diaphragm 22, and the backplane 23 are sequentially stacked in a direction from the connecting portion 12 away from the glass plate 30. The filling 40 is between the inner side surface 111 and the light guide plate 21, the diaphragm 22, and the backplane 23. The diaphragm 22 may be one or a combination of a prism film, a diffusion film, a microprism film, a brightness enhancement film, a reflection film, and other suitable optical films. It can be understood that the backlight module can further include a backlight (not shown) disposed on the backplane 23.

Because the filling 40 is formed by curing liquid colloid, even if a width of a gap between the inner side surface 111 and the light guide plate 21, the diaphragm 22, and the backplane 23 is inconsistent, the filling 40 adequately fills in the gap having inconsistent widths.

The liquid colloid may be a light-shielding optical glue, such as silica gel, so that the filling 40 prevents light leakage. A chemical composition and curing characteristics of the liquid colloid can be selected according to actual needs. The filling 40 fills in the gap between the backlight module 20 and the inner side surface 111, thereby improving prevention of light leakage.

In one embodiment, the glass plate 30 and the connecting portion 12 are bonded together by an adhesive tape 50.

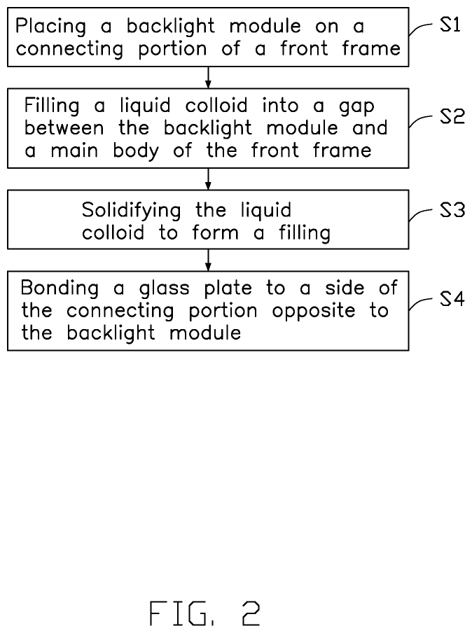

FIG. 2 shows a flowchart of an embodiment of a method of making a display device. The method is provided by way of embodiment, as there are a variety of ways to carry out the method. The method described below can be carried out using the configurations illustrated in FIG. 1, for example, and various elements of the figure are referenced in explaining the example method. Each block shown in FIG. 2 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure.

At block S1, the backlight module 20 is placed on the connecting portion 12 of the front frame 10.

The front frame 10 includes a main body 11 and a connecting portion 12. The main body 11 surrounds the backlight module 20, and the main body 11 includes an inner side surface 111 facing the backlight module 20. The connecting portion 12 extends from the inner side surface 111.

At block S2, the liquid colloid is filled by a dispensing device into the gap between the backlight module 20 and the main body 11.

The dispensing device may be a mechanical arm, a three-axis platform, or a hand-held mechanism.

At block S3, the liquid colloid is solidified to form the filling 40.

The liquid colloid is solidified by controlling an ambient temperature, humidity, and curing time according to curing conditions of the liquid colloid.

At block S4, the glass plate 30 is bonded to the side of the connecting portion 12 opposite to the backlight module 20.

The glass plate 30 and the connecting portion 12 may be bonded together by the adhesive tape 50.

The display device 100 can be applied in an electronic device (not shown), such as a television, a mobile phone, a computer, or the like that requires display function.

In summary, the display device 100 includes the filling 40 filled in between the backlight module 20 and the inner side surface 111. Compared with the related art, not only is assembly of the display device 100 simplified and production and processing costs reduced, but also light leakage prevention is improved, and the display device 100 has high versatility of application.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A display device comprising:
a front frame;
a backlight module; and
a glass plate; wherein:
the glass plate is arranged facing the backlight module;
the front frame comprises a main body and a connecting portion;
the main body surrounds the backlight module and the glass plate, the main body comprising an inner side surface facing the backlight module and the glass plate;
the connecting portion extends from the inner side surface into a gap defined between the backlight module and the glass plate;
the backlight module abuts against a side of the connecting portion facing away from the glass plate;
a filling is filled in between the backlight module and the inner side surface; and
the filling is formed by curing a liquid colloid.

2. The display device of claim 1, wherein:
the connecting portion is a plate extending perpendicularly from the inner side surface.

3. The display device of claim 1, wherein:
the main body further comprises an outer side surface facing away from the backlight module and the glass plate; and
the outer side surface is a curved surface.

4. The display device of claim 1, wherein:
the backlight module comprises a light guide plate, a diaphragm, and a backplane;
light guide plate, the diaphragm, and the backplane are sequentially stacked in a direction from the connecting portion away from the glass plate;
the filling is filled in between the inner side surface and the light guide plate, the diaphragm, and the backplane.

5. The display device of claim 4, wherein:
a width of a gap between the inner side surface and the light guide plate, a width of a gap between the inner side surface and the diaphragm, and a width of a gap between the inner side surface and the backplane are not equal.

6. The display device of claim 1, wherein:
the liquid colloid is a light-shielding optical glue.

7. The display device of claim 1, wherein:
the glass plate is bonded to the connecting portion by an adhesive tape.

8. A method of making a display device comprising a front frame, a backlight module, and a glass plate, the method comprising:
placing the backlight module on a connecting portion of the front frame;
filling a liquid colloid into a gap defined between the backlight module and a main body of the front frame;
curing the liquid colloid to form a filling; and
bonding the glass plate to a side of the connecting portion opposite to the backlight module.

9. The method of claim 8, wherein:
the connecting portion is a plate extending perpendicularly from the inner side surface.

10. The method of claim 9, wherein:
the backlight module comprises a light guide plate, a diaphragm, and a backplane;
light guide plate, the diaphragm, and the backplane are sequentially stacked in a direction from the connecting portion away from the glass plate;
the filling is filled in between the inner side surface and the light guide plate, the diaphragm, and the backplane.

11. The method of claim 10, wherein:
a width of a gap between the inner side surface and the light guide plate, a width of a gap between the inner side surface and the diaphragm, and a width of a gap between the inner side surface and the backplane are not equal.

12. The method of claim 11, wherein:
the liquid colloid is a light-shielding optical glue.

13. The method of claim 12, wherein:
the glass plate is bonded to the connecting portion by an adhesive tape.
